(19) United States
(12) Patent Application Publication
(10) Pub. No.: US 2003/0128214 A1
(43) Pub. Date: Jul. 10, 2003

(54) Framework for domain-independent archetype modeling

(75) Inventors: David Oglesby, Maple Grove, MN (US); Kirk Schloegel, Independence, MN (US); Devesh Bhatt, Maple Grove, MN (US); Eric Engstrom, Shoreview, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/242,201

(22) Filed: Sep. 12, 2002

Related U.S. Application Data
(60) Provisional application No. 60/322,339, filed on Sep. 14, 2001.

(51) Int. Cl. G06T 15/70

(52) U.S. Cl. 345/473

(57) ABSTRACT

A framework provides for the creation, use, and management of archetypes as a basic building block for graphical model-based development environments. Archetypes are user-definable, domain-independent modeling entities that can contain one or more domain-specific models as well as archetype-specific operations, such as code generation. Archetypes may contain portals that are the explicit application programming interfaces of archetypes. Users define archetype definitions (including visual representations, portals, implementations, and operations) and they or others can then instantiate instances of defined archetypes into different modeling notations. The semantic interpretation of the archetype instances via archetype- and implementation-specific operations provide support for high-level operations such as code generation, model transformations, and model analyses.

This application claims the benefit of priority under 35 U.S.C. 119(e) to U.S. Provisional Patent Application Serial No. 60/322,339, filed Sep. 14, 2001, which is incorporated herein by reference in its entirety.

### GOVERNMENT FUNDING

The invention described herein was made with U.S. Government support under Grant Number F33615-00-C-1705 awarded by the United States Air Force. The United States Government has certain rights in the invention.

### FIELD OF THE INVENTION

The present invention relates to model-based development for system design, and in particular to a graphical design pattern based modeling framework.

### BACKGROUND OF THE INVENTION

The history of software development has shown a trend towards higher levels of abstraction. Each level allows the developer to focus more directly on solving the problem at hand rather than implementation details. As software developers target more complex problems, it is important to provide better tools that support increasing levels of abstraction. Domain Specific Modeling Notations (DSMNs) represent higher levels of abstraction than general software-oriented notations (e.g., the UML) because they model problems using concepts from their own domains rather than in terms of software entities. Hence, DSMNs are less generally applicable than generic software tools, but more powerful within their domains because modeling entities have more semantics associated with them. Automatic code generators can be used to, translate domain-specific designs to the more general software domain. This approach has been demonstrated to be more efficient with respect to development time than modeling with generic notations directly.

Modeling domains are DSMNs defined by metamodels. These metamodels may be graphically represented as in Vanderbilt's GME or Honeywell's DOME, or they may be hardcoded in tools as in more traditional modeling tools such as Rational Rose. A domain model belongs to a modeling domain. Such a model references its metamodel to determine the type of entities that can be instantiated, the properties of those entities, allowable connections between entities, etc. There may be many domain models in a system embedded at various levels. Entities in a model are said to be native if they are defined in the metamodel for that modeling domain. There are a large and increasing number of modeling domains of interest to different people, and each domain is specific to certain types of problems. Thus it is expensive to build from scratch tools for all domain-specific modeling notations of interest. Metamodeling tools reduce the cost of creating domain specific modeling tools by allowing a user to specify the syntax and semantics of a notation in the form of a metamodel and by creating the supporting tools automatically. Hence, metamodeling tools support the creation and use of DSMNs.

There are multiple areas for improvement in DSMN tools. Among existing metamodeling tools, Vanderbilt's GME supports metamodel reuse, and Honeywell's DOME supports reuse within a model; but none of the metamodeling packages provide adequate support for reuse of model elements within and across modeling domains. The use of design patterns as first-class graphical modeling entities holds the potential of supporting reuse on many levels. However, this potential has not been realized because the variant and cross-domain nature of design patterns has led to difficulties in modeling and interpreting them in graphical modeling notations.

### SUMMARY OF THE INVENTION

A framework provides for the creation, use, and management of archetypes as a basic building block for graphical model-based development environments. Archetypes are user-definable, domain-independent modeling entities that can contain one or more domain-specific models as well as archetype-specific operations, such as those that support code generation. Archetypes may contain portals that are the explicit application programming interface (API) of archetypes. Users create archetype definitions (including visual representations, portals, implementations, operations, and attributes) and they or others can then instantiate instances of defined archetypes into different modeling notations.

In one embodiment, archetype instances can be used as first-class objects in arbitrary modeling environments. This enables developers to easily build up models by simply instantiating existing archetype definitions into domain-specific models and by creating new archetype definitions to be used in the same or other models. Archetype instances can be dropped into different modeling notations. The properties, domain-specific subdiagrams, and portals support their interpretation in certain contexts, and archetype-specific operations provide additional interpretation for such purposes as analysis or code generation within the context of the whole domain model. For example, automatic code generation operations can be used to interpret an archetype as C++ or Java programming language classes for the developer. Archetypes support the generation of artifacts in conjunction with the generators of the models in which they are instantiated and those of their implementation subdiagrams.

In a further embodiment, the archetype-support framework provides a higher level of abstraction than current graphical model-based development environments. This is because it provides the capability for users to define and compose high-level, hierarchical, multi-notation modeling entities. Essentially, archetypes provide the mechanism for complex, multi-domain modeling information to be abstracted to a single black-box modeling entity.

An archetype instance, in one embodiment, is a node or an arc on a graph that has internal details with which the user need not be concerned. Each archetype definition can have multiple implementations, which are possibly overlapping sets of subdiagrams and archetype- and implementation-specific operations and attributes. A subdiagram is a hierarchical construct that allows the representation of a complicated portion of a graph as a simple node or arc. This node or arc then acts as a placeholder, simplifying the graph for the user who may choose to view the subdiagram at his or her leisure. Each archetype instance uses only one of the implementations of its associated archetype definition at a time. The correct implementation to use at a given time can be selected in a number of ways (e.g., via attributes on the archetype or one of its portals, by specification in the encompassing model, or by a query mechanism). Multiple instances of archetypes may share an implementation, so changes to the implementation affect all of those instances. Archetype instances sharing an implementation allow for aspect weaving. This provides a single point of concern for the aspect being modeled. In addition, since archetype instances can be included in the implementation of other archetype definitions, it is easy to create powerful new archetype definitions by composing or extending existing ones.

In still further embodiments, the archetype-support framework enables domain-level reuse. A given archetype definition may be instantiated in multiple models within a domain and in multiple domains as well. The archetype-support framework supports modeling of cross-domain aspects by defining multiple subdiagrams from different domains.

### BRIEF DESCRIPTION OF THE DRAWINGS

FIG. 1 is a block diagram example of the visual representation of a dog archetype definition.

FIGS. 2A, 2B and 2C are block diagram examples of subdiagrams of the dog archetype definition in FIG. 1.

FIG. 3A is a block diagram example of the visual representation of the dog archetype definition with a portal.

FIG. 3B is a structural subdiagram of a dog archetype definition with a portal.

FIG. 3C is a visual representation of a dog archetype definition with userdefined attributes and a portal.

FIG. 4 is a block diagram example of various archetype instances of the dog archetype definition of FIG. 3C that have been connected to each other and to other objects via arcs.

FIG. 5 is a block diagram of an archetype subdiagram with a portal coupled to a portal on another archetype's instance that is, in turn, coupled to an object in its subdiagram.

FIG. 6 is a block diagram representation of an archetype definition with multiple instances and multiple implementations.

FIG. 7A is a block diagram representation of multiple connections through a portal.

FIG. 7B is a flattened diagram representation of the diagram of FIG. 7A.

FIG. 8A is a block diagram representation of multiple arcs of different types in different directions through a portal.

FIG. 8B is a flattened diagram representation of the diagram of FIG. 8A.

FIG. 9A is a block diagram representation of multiple arcs of different types in different directions through a portal with the addition of equivalence arcs.

FIG. 9B is a flattened diagram representation of the diagram of FIG. 9A.

FIG. 10 is a block diagram of a watchdog communication archetype definition.

FIG. 11 is a block diagram of connected archetype instances with propagating attribute values.

FIG. 12 is a block diagram showing internal details of a composite archetype definition.

FIG. 13 is a block diagram example of external connectivity to an instance of the composite archetype definition of FIG. 12.

FIG. 14 is a block diagram example of a UML class diagram domain model that is composed of five UML class entities and two Publish/Subscribe archetype instances.

FIG. 15 is a block diagram example of a subdiagram that conforms to a UML class diagram modeling notation.

FIG. 16 is a block diagram example of a further subdiagram that conforms to a Periodic Event modeling notation.

FIG. 17 is a block diagram example of a further subdiagram that conforms to a State-Transition diagram modeling notation.

### DETAILED DESCRIPTION OF THE INVENTION

The following description and drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples.

The present invention is an archetype-based framework providing ease of graphical model-based development. It provides a graphical frame of reference that is closely identifiable to a problem and provides multiple levels of abstraction of the solution. Users create archetype definitions comprised of visual representations, portals, implementations, archetype- and implementation-specific attributes and operations. Then users or other model developers instantiate instances of these definitions into graphical models, supply values for their attributes, and connect them to native modeling objects (i.e., those defined to be used within the given modeling notation) and other archetype instances by arcs defined within the modeling domain as well as by domain-independent equivalence arcs. Archetype- and implementation-specific operations can then be used to interpret the archetype instances within the models. For example, textual artifacts (programming code, configuration files, documentation, etc.) can be automatically generated from the archetype instance.

This description of the invention starts with a simple example of an archetype definition that models a dog, and shows how the different abstractions of the dog are used to simplify model-based development. A more generalized discussion of the invention follows, providing further detail regarding the constructs utilized to connect archetypes to provide archetype interaction, and rich transformation into textual artifacts.

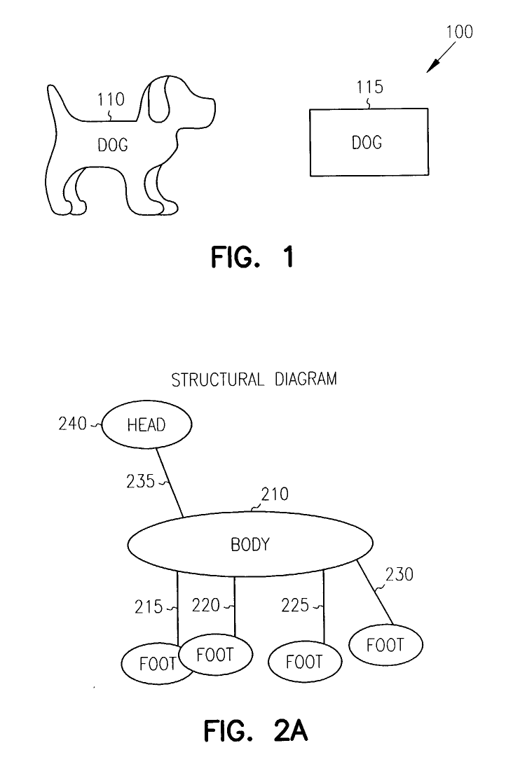

Two visual representations for an archetype definition are indicated at 100 in FIG. 1. The archetype 100 represents a dog 110 in stylized form, or in block form at 115. A user creates an archetype definition, and also its visual representation, as seen at 100. The user then creates one or more implementations that are each related to a problem variant. In this example, implementations may comprise puppy, adult, senior and poodle.

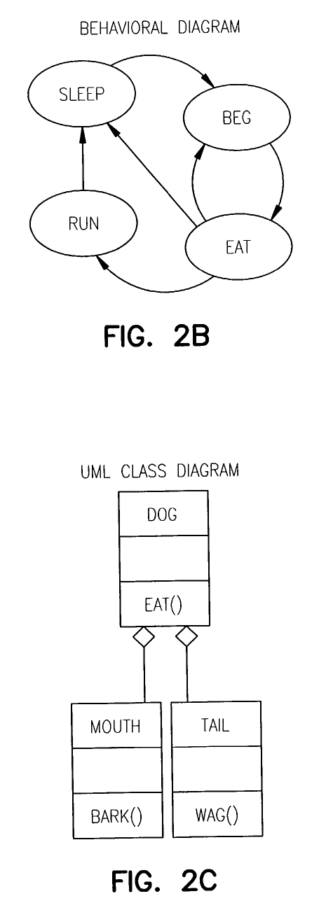

FIGS. 2A-C are subdiagrams of an implementation of the dog archetype definition. In the subdiagram of FIG. 2A, the structural body of the dog is graphically shown at 210. As shown, the body is rather non-descript. It could, however be quite graphically correct if desired, making it very domain specific. The dog 210 includes legs/feet 215, 220, 225 and 230. A neck 235 and head 240 are also shown. Other types of subdiagrams, such as a behavioral diagram of FIG. 2B, a UML class diagram of FIG. 2C, and others such as a quality of service (QOS) or timing diagram may also be represented. In the behavioral subdiagram, the behaviors sleep, beg, run, and eat are shown in a state diagram format with transitions represented by lines with arrows. The UML diagram associates the behaviors in a hierarchy of parts of the dog, with the behavior of eat( ) associated with dog, bark( ) with mouth and wag( ) with tail.

Archetype- and implementation-specific operations are then defined, such as chase cat, pull sled, hunt, guard, or other operations normally performed by a dog, or other entity being modeled. Other synthesis or analysis operations can also be defined. For example, the user can create an operation that interprets the selected implementation of the archetype definition to generate textual artifacts, such as Java source code, from archetype instances.

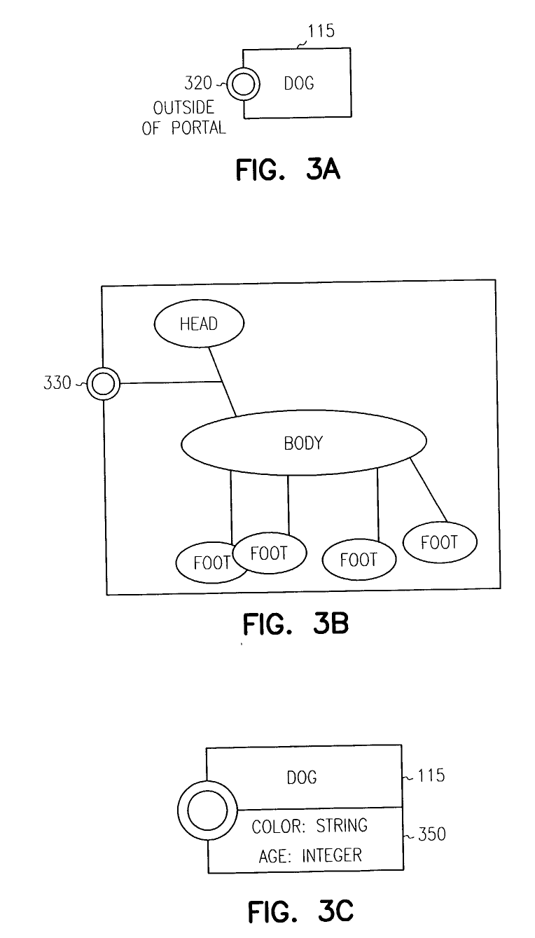

In FIG. 3A, a portal 320 is represented as connected to the dog archetype definition. The portal 320 provides an interface to the dog archetype definition, and logically connects to what is connected to the corresponding portal in the subdiagrams as seen below. The portal 320 represented in FIG. 3A is the outside of the portal. It hides the details on the inside of the portal as seen at 330 in FIG. 3B, which is a structural diagram consistent with FIG. 2A. Note that 320 and 330 are actually two different modeling entities. However, conceptually they appear to be opposite sides of a single logical portal. The portals serve to push/pull information into/out of archetype instances in order to complete the contexts of the archetype instances and the domain models. Attributes 350 may also be defined on the archetype definition and/or on its portals as seen in FIG. 3C. Defining one or more attributes parameterizes the archetype. Such attributes 350 include color and age, represented by a string value or integer value as shown in FIG. 3C.

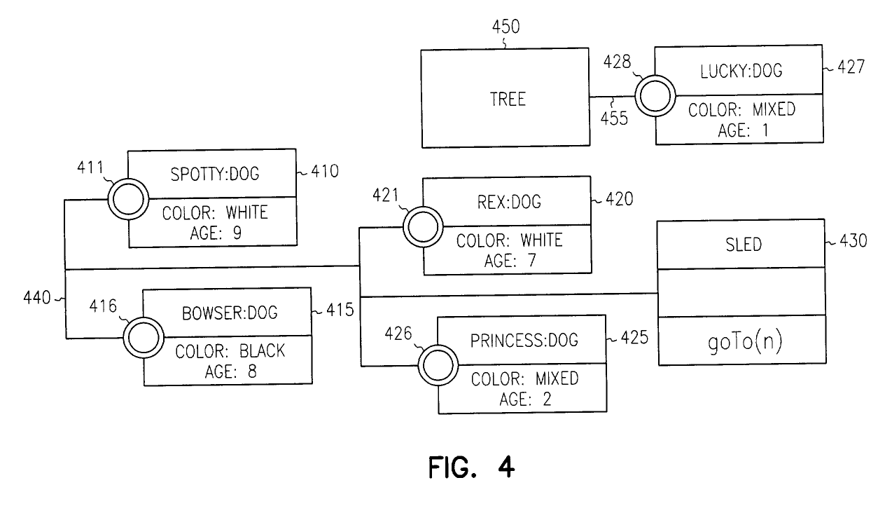

In FIG. 4, multiple instances of the dog archetype definition in a modeling domain are created as indicated at 410, 415, 420, 425, and 427 with corresponding portals 411, 416, 421, 426 and 428. All instances may use archetype-specific operations, and all instances with the same implementation share implementationspecific operations and subdiagrams in one embodiment. An instance of a sled class is also shown at 430. A modeler completes the context of the archetype instances by connecting them to other modeling elements via the portals by the use of arcs such as 440, and also by providing appropriate values for the archetype and/or portal attributes for each instance. The attributes in this example are color and age as shown. Connecting multiple archetypes, via portals and arcs to native modeling entities (such as classes in the UML class diagram in this example) thus visually develops solutions to domain specific problems while completing the context of the archetype instances in support of rich code generation and analysis. This simple example is representative of harnessing dogs to a sled for pulling the sled. Instance 427 of the dog archetype definition is coupled to a tree object 450 by an arc 455. This represents tying the dog to the tree.

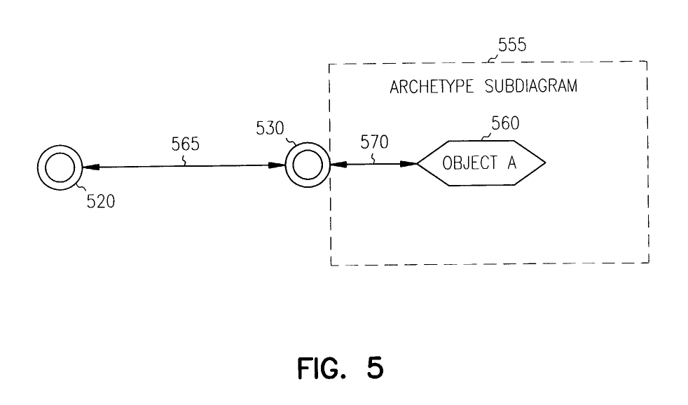

FIG. 5 shows a subdiagram of an archetype definition that contains an archetype instance 555 and a portal 520. The archetype instance encapsulates a subdiagram at 555. Note that this composited view shows several layers of abstraction for the sake of this example, both an archetype instance and a subdiagram in its definition are visible. Hence, portal 530 represents both sides of a portal: one external to the archetype instance; and one internal to the subdiagram. The subdiagram includes an object A at 560. An equivalence arc 565 couples portal 520 to portal 530, which in turn is coupled to object A 560 by an equivalence arc 570. The combination of portals and equivalence arcs result in portal 520 logically appearing as though it is object A 560. Connections to the outside of portal 520 will be interpreted as connecting directly to object A 560.

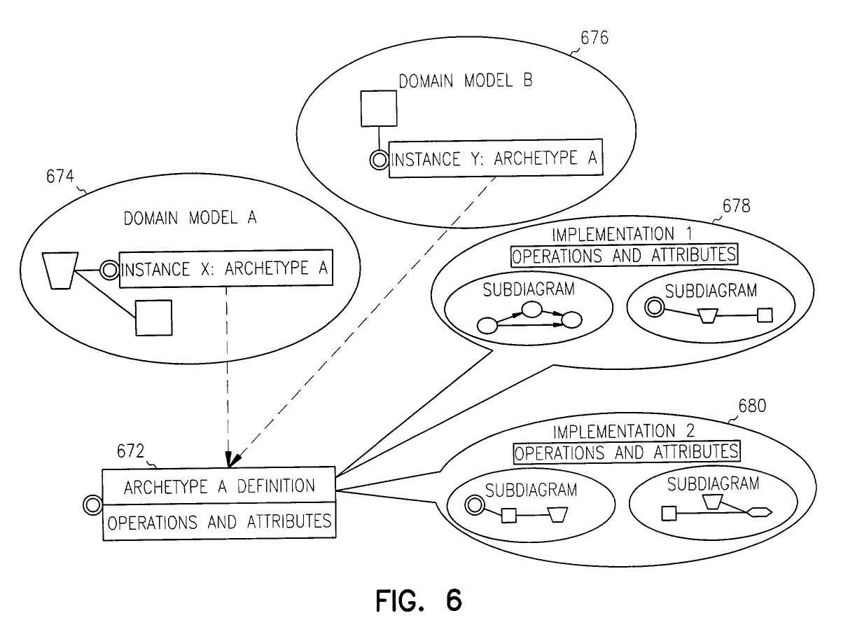

In FIG. 6, an archetype definition is shown at 672. One or more implementations of the archetype definition 678 and 680 are shown each with associated subdiagrams. Domain models are indicated at 674 and 676. Each domain model contains an instance of the archetype definition 672. The broken lines show how archetype instances point to their definitions. It is by this mechanism that multiple archetype instances can share implementations.

In a domain model, powerful and flexible archetype usage is supported by connecting archetype instances to entities in the model (including native entities and other archetype instances) by arcs defined within the modeling domain as well as by domain-independent equivalence arcs. Users and developers can specify the appropriate connection for a given instance of an archetype. Archetype instances can be tailored to their contexts via connections (and by assigning specific values to attributes). In general, archetypes are self-contained—interacting only though portals with other modeling entities within the domain model.

Semantically, connections to a portal on an archetype instance in an domain model complete a connection to one or more elements within a subdiagram of the archetype definition that corresponds to the modeling domain of the model in which the instance resides. Consider a Unified Modeling Language (UML) class diagram as an example. Connecting a class to an archetype instance using a generalization arc has meaning within the UML domain only if it continues through the archetype portal to a valid UML entity in a subdiagram of the archetype definition. Portals are used to make such connections clear. The portal is something of a window into the archetype definition. It provides a view of the archetype's implementation, allowing arcs to be connected from an object external to an archetype instance to an object in a subdiagram of an archetype definition. It also ensures that these connections are made to only those objects the archetype designer has specified. That is, it provides a mechanism for constraint checking. Through its portals, a model developer completes the context of an archetype instance while also completing the context of the domain model in which the instance appears.

In an archetype definition, a user can connect the inside of a portal to any entity in any of its subdiagrams that are defined in the given domain. The other side of portals on an archetype instance, on the other hand, can be connected only by the kinds of arcs in the directions specified in the archetype definition (except for an equivalence arc described below). For every arc that connects to a portal, there should be at least one corresponding arc (of the same type and direction) on the other side of the portal so that the connection can be logically completed. This allows the archetype instance to be flattened. In one embodiment, when an archetype instance is flattened, its visual representation is replaced by a selected subdiagram. New arcs are then instantiated to realize the logical connections that had existed through the archetype instance's portals. In some embodiments this view may be represented explicitly, in others there may be no such view, but the resolution of equivalence arcs into domain-specific arcs may occur implicitly.

Some archetype designs may involve multiple arcs connected to either or both sides of a portal. Such a state can lead to difficulty in interpreting composed models and/or constructing flattened diagrams when multiple arcs of different types or directions are connected to one side of a portal. The user is free to define archetype-specific operations to interpret the meaning of the multiple arcs in any case. However, if no such operations are defined, default rules can exist that govern the connection of arcs to portals.

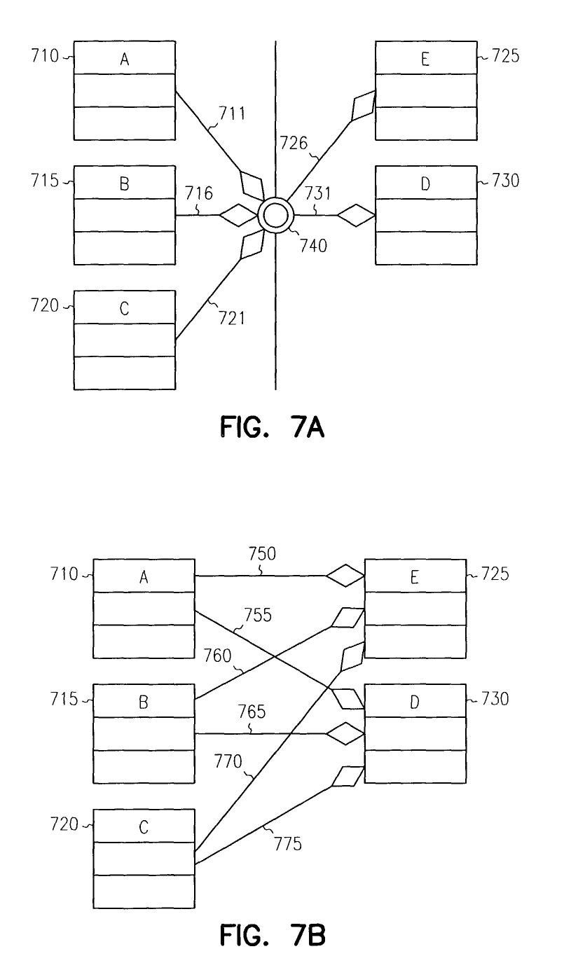

In one embodiment the default rules that govern the connection of arcs to portals indicate that if n arcs are connected to one side of a portal and m corresponding arcs (i.e., the same type of arc with the same direction) are connected to its other side, then the flattened diagram will contain nm arcs. For example, FIG. 7A shows a case with three UML classes 710, 715 and 720 with corresponding arcs 711, 716 and 721 on one side of a portal 740, and two classes 725 and 730 with corresponding arcs 726 and 731 on the other. A flattened UML class diagram is shown in FIG. 7B, with the portal replaced by direct arcs 750, 755, 760, 765, 770 and 775. Note that this example does not differentiate the inside of an archetype from the outside. These rules do not take into account to which side of the portal arcs connect. They treat portals as bi-directional entities. On the other hand, user-defined operations may take the side of the portal into account when resolving connections.

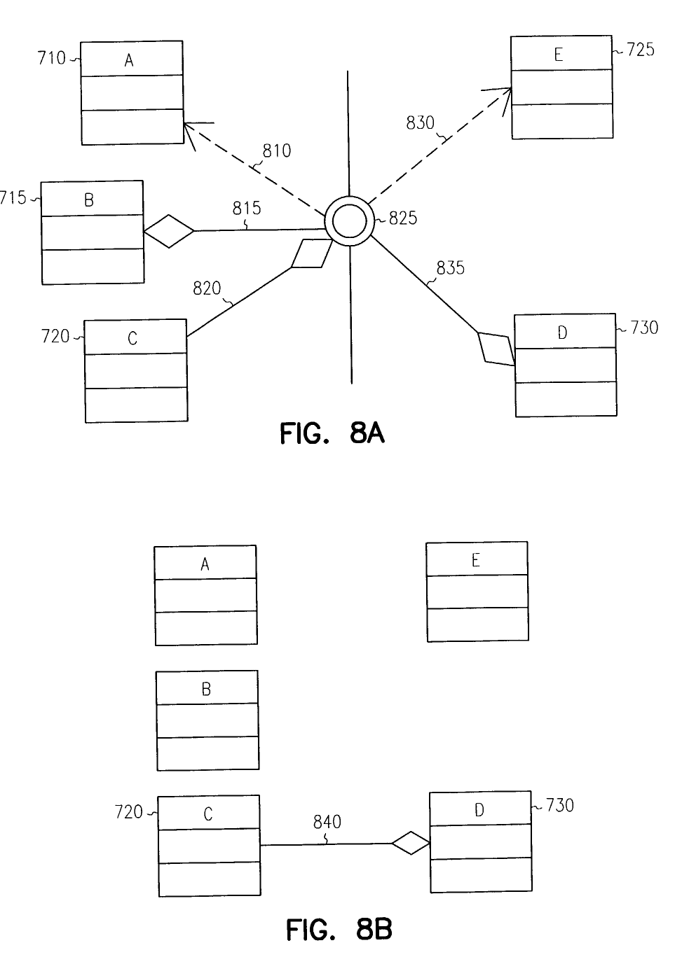

If multiple non-corresponding arcs connect to one or both sides of a portal, then only the sets of corresponding arcs are unified by this process. FIG. 8A provides an example. Here, three arcs 810, 815 and 820 of different type and direction are connected to one side of a portal 825. Any one arc can be connected between either node 730 or node 725 and the right side of the portal as shown by arcs 830 and 835. However, the resulting flattened diagram will include unmatched arcs, because the direction of arc 830 is in the wrong direction to match 810, and there is no arc matching 815 (835 is in the wrong direction). Hence the semantic meaning of the archetype will be lost. The flattened diagram would appear as in FIG. 8B, with only an arc 840 between UML classes 720 and 730. Such conflicts can be detected a priori and unallowed. The difficulty that arises is that the user may need to be exposed to many internal details of an archetype's definition.

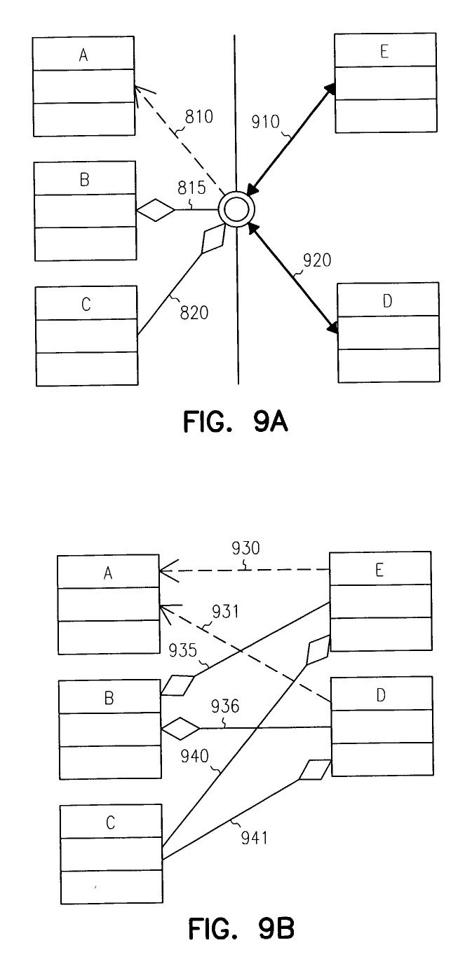

This difficulty is addressed by a special domain-independent arc that is usable in any modeling domain to connect native modeling entities as well as portals to other portals. It is referred to as the equivalence arc and is shown at 910 and 920 FIG. 9A. The equivalence arc can be thought of as a wildcard arc. In a flattened diagram, equivalence arcs are replaced by every arc that connects to the other side of the portal. Hence, flattened diagrams will never contain the equivalence arc. It will always be replaced in this manner. Therefore, flattened diagrams will contain only domain-specific modeling entities. FIG. 9B shows the flattened diagram for FIG. 9A. There are two arcs 930 and 931 replacing arc 810 and equivalence arcs 910 and 920, two arcs 935 and 936 replacing arc 815 and equivalence arcs 910 and 920, and two arcs 940 and 941 replacing arc 820 and equivalence arcs 910 and 920.

The equivalence arc can be thought of as an import/export arc. This use of the equivalence arc gives the semantic appearance that the other side of the portal is equivalent to the entity to which the equivalence arc is connected. For example, when the inside of a portal on an archetype definition is connected by an equivalence arc, the user is allowed to connect the outside of the portal on an instance with any native modeling notation arc or equivalence arc. The information propagates out of the archetype into the domain model. The reverse situation is also true whenever the equivalence arc is attached to the outside of an archetype instance. Here, the appearance is that information propagates into the archetype. Also, using the equivalence arc outside of an archetype allows a user to connect to the archetype with less concern for the details of its implementation as all connections will be made in the corresponding flattened diagram.

When equivalence arcs attach to both sides of a portal, the entities to which the equivalence arcs connect are considered to be equivalent.

The semantic interpretations of equivalence arc connections are transitive across chains of multiple portal and equivalence arc links. For example, suppose an equivalence arc connects a domain-specific modeling entity to a portal. The other side of the portal is also connected by an equivalence arc to a second portal. The other side of this portal may also be connected by an equivalence arc to a third portal, and so on. Eventually, a domain-specific modeling entity (either node or arc) will attach to the end of this chain. The result is as if only a single equivalence arc connected the domain-specific terminals. Also, multiple modeling entities either domain-independent or domain-specific may fan out or fan in from this chain. The result is that the terminals on either end will consist of sets of domain-specific modeling entities.

This feature is especially useful for allowing entities to connect to a portal on an archetype instance that is embedded in the subdiagram of another archetype's definition. This supports archetype hierarchical composition. For example, in FIG. 4, Portal 430 is on an instance of an archetype 455. By connecting it to 420 in the 30 subdiagram of another archetype definition, a connection to an instance of 420 is the same as connecting directly to 430.

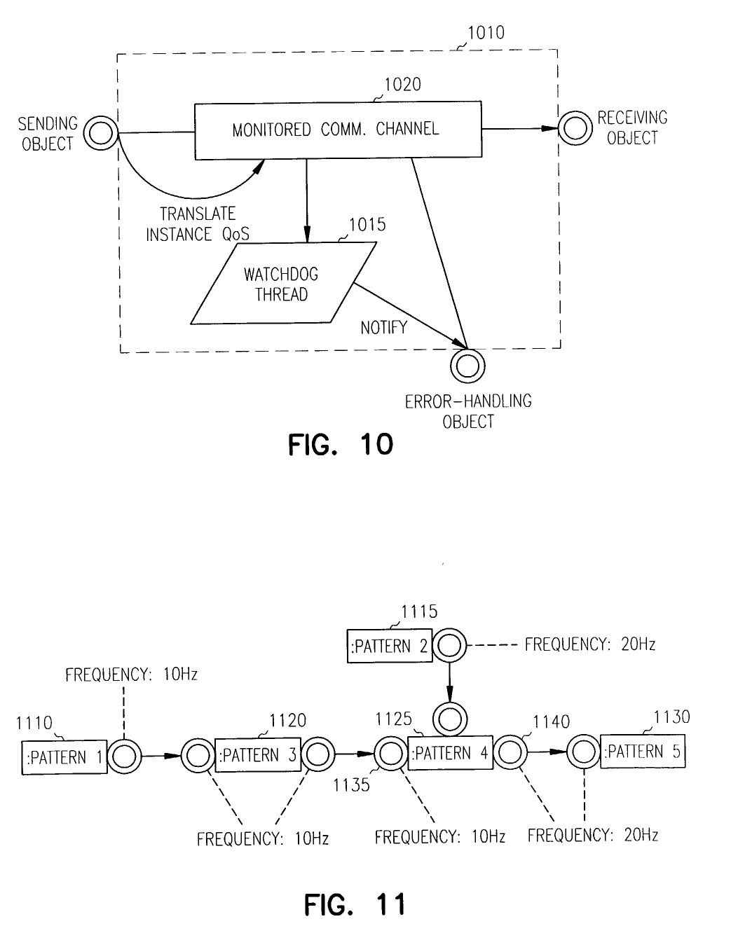

The semantic details of some implementations may be dependent upon certain instance-specific details. Consider a watchdog communication archetype as shown in FIG. 10 at 1010. In this archetype, communications are monitored at 1020. If an error occurs, a watchdog thread 1015 puts the system into a safe state. This archetype 1010 is flexible to a degree in that the communication may occur over the TCP or UDP network communication protocols. Archetype definitions have user-defined attributes that can be used to select among optional implementation details. For example, in FIG. 10 the code generator and other archetype-specific operations that are associated with the watchdog archetype can be defined to select among communication protocols based on a quality-of-service attribute (for example, the maximum communication error rate) specified on the archetype definition.

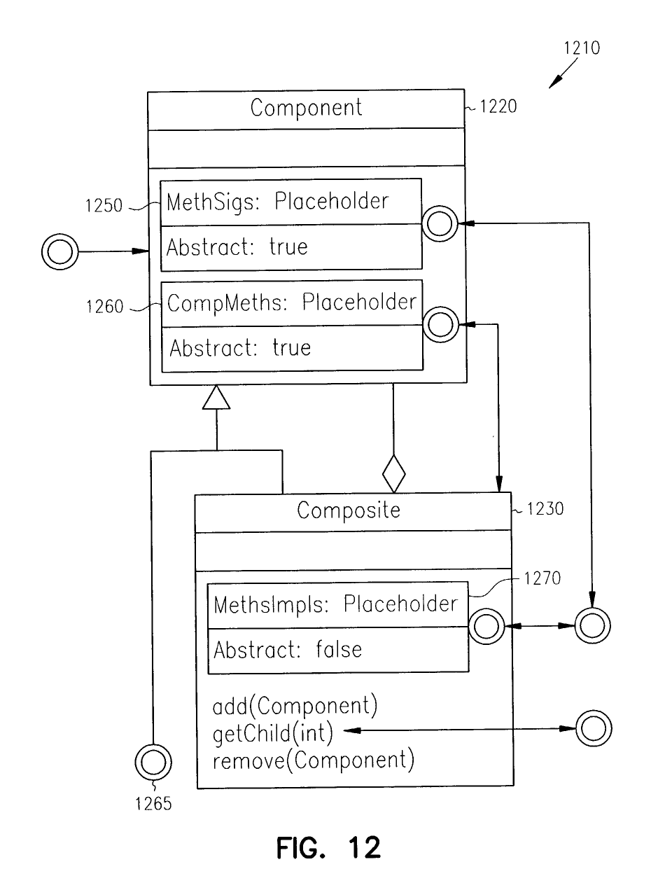

Users can define attributes on both archetype definitions as well as their portals. Values for these attributes can be propagated into, out of, across and even between archetypes. For example, a portal on an archetype definition may have a periodicity attribute that specifies the rate at which information will flow through it. The values assigned to this attribute on instances of this archetype could propagate through the archetype instance to the entities connected to it through a portal. The attribute could follow a chain of portals in order to complete the instantiation of a model as shown in FIG. 11.

Five archetype instances, 1110, 1115, 1120, 1125 and 1130 are shown connected. Archetype 1110 has an associated frequency of 10Hz that propagates through archetype 1120 to a left portal 1135 of archetype 1125. Archetype 1125 has two different frequency inputs, 10 Hz originating from archetype 1110 and 20Hz originating from archetype 1115. It propagates the higher frequency to an output portal 1140, which propagates it on to archetype 1130. Alternatively, it could propagate the lower frequency or another frequency altogether dependent upon the defined semantics of the archetype. The mechanism for the propagation of attribute values in this way can be fully specified by the user as archetype- or implementation-specific operations.

Many archetypes have a number of different implementations as seen above with respect to the dog example. Logically, an archetype has one specific meaning, but its implementations may vary depending on the circumstances of its use. While attributes allow for adaptations to the implementation details of an archetype (such as TCP versus UDP), multiple implementations accommodate fundamentally different implementation approaches. For example, an archetype may be implemented differently on different kinds of middleware, a “notification” archetype can use multiple implementations to allow for lazy or eager evaluation, and a routing archetype can have various fault-tolerant implementations to rout around dead links in the physical network. These differences are captured in models for the purposes of artifact generation, verification, validation, and system analysis. The context in which an archetype is used may change the implementation significantly, but should not change the high-level semantics of the archetype.

One important aspect of archetypes is the ability to combine and connect them. Archetype instances can both be embedded in the subdiagrams of other archetype definitions and connected to other instances at their portals. Archetype instances can also be embedded as sub-entities in other domain-specific modeling entities.

Various operations, such as artifact generation, should be encapsulated within archetypes. This approach has a number of advantages. It is beneficial from a software-engineering standpoint as interpretation details for an archetype are hidden within it. Typically, the archetype developer will take care of the operation details associated with the specific archetype during its design.

Encapsulation explicitly links operations to model entities. This removes the requirement that top-level operations (e.g., code generation routines) contain hard-coded knowledge of every possible utility operation. Instead, the model is simply traversed, and as each archetype is encountered, its relevant operation is executed. For example, if the top level operation is a specific analysis, the archetype-specific operations that support the analysis are performed at each archetype instance. Further, encapsulation allows for the dynamic resolution of multiple archetype implementations.

A key operation that archetypes support is the generation of code from the model. Managing complexity is a key issue for code generation tools. This is because the complexity of the model increases with the richness and flexibility of the desired level of code generation. That is, if you want to generate code for many different attributes of a system, then all of these attributes must be modeled. The current invention provides a framework that lets the user control the internal archetype complexity by allowing for multiple implementations of a single archetype as well as multiple instances and types of subdiagrams within various implementations. In their simplest form, archetypes can be used as simply as other first-class modeling entities to build up complex models. However, they can also allow for arbitrary amounts of additional information specification in order to support rich code generation. However, even with multiple implementations and subdiagrams built from diverse modeling domains, archetype interfaces remain simple and straightforward to use. As such, archetypes provide small, easily understood, compact units of composition that specify arbitrarily complex, multi-attribute, and hierarchical structures to maximize code generation while also managing complexity.

Three archetypes in FIG. 12 cooperate to model the composite design pattern from Design Patterns by Gamma, Helm, Johnson, and Vlissides. The composite pattern allows a client to treat a group of components as an individual component, presenting a single interface to the client. A UML class diagram that models the software architecture of the archetype is shown in FIG. 12 at 1210. A UML class named Component 1220 contains two Placeholder archetypes. Note the colons in FIG. 12 denote that Placeholder is the name of the archetype definition, the instance name appears before the colon. The purpose of the Placeholder archetype is to provide a placeholder for a modeling entity or collection of modeling entities. The first Placeholder archetype, MethSigs 1250, is connected to a portal, through which all operations that belong to all classes that inherit from Component (including Composite) are imported. This mechanism allows the Component class 1220 to access the signatures of the operations of all its children. The second Placeholder archetype, CompMeths 1260, connects to the Composite class. This mechanism provides the Component class with the necessary operations (add, remove, getChild) to manage composites. This archetype instance allows us to define the composite operations in only one place. The composited classes are specified by connecting them via inheritance (or equivalence arcs) to the outside of portal 1265.

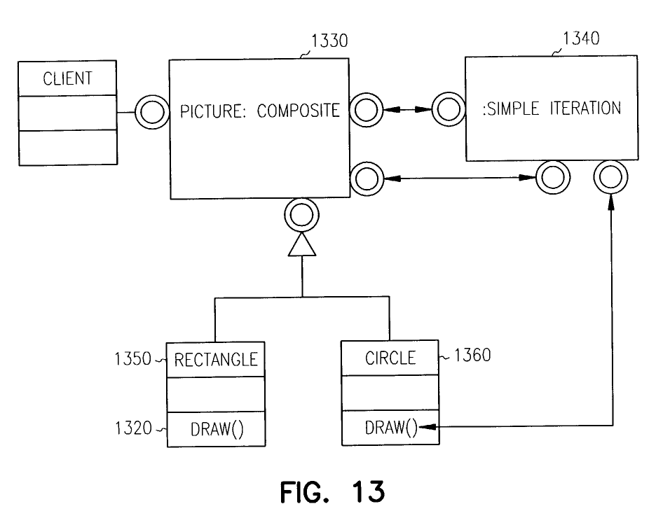

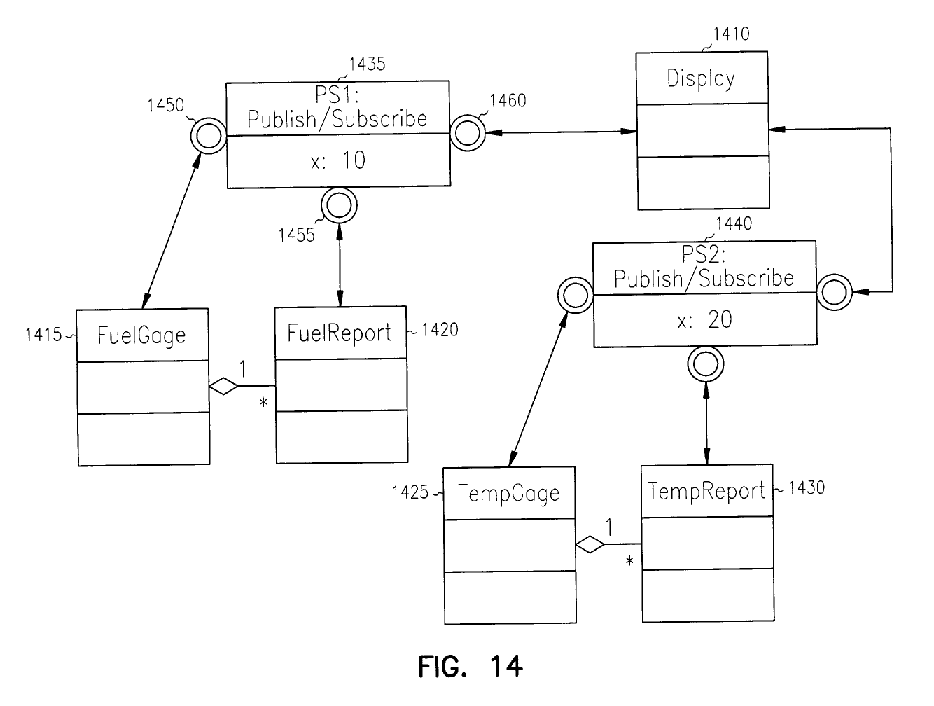

The Composite class 1230 contains another Placeholder archetype instance, Methlmpls 1270. This archetype may expand to any number of methods, and should be connected via equivalence arcs with a set of method implementations. This use of the Placcholder archetype allows the Composite archetype 1230 to compose components with an arbitrary number of methods. It also links with a SimpleIteration archetype 1340 to support different kinds of reductions across different child operations. This is important because the reduction of different operations can require different pre- and post-call processing. Consider the instance in FIG. 13. In this example, a Draw( ) operation called on a composite can simply iterate over all children and call their own Draw( ) operations on each of them. However, if the components provided a getSize( ) operation, then the composite operation would need to calculate its size based on the sizes of its children. Hence it would not only need to call the operation on all children, but also accumulate their return values. This would require a different implementation of the SimpleIteration archetype than the first case. The Placeholder archetype combined with the portal to which it connects allow the flexibility to specify an arbitrary number of operations with multiple types of iteration or reduction across the children while still supporting rich code generation and analysis.

The SimpleIteration archetype 1340 shown in FIG. 13 takes one or more operations as inputs and generates the corresponding composed operation bodies according to some rule. As a simple example it might generate a routine that iterates over all children and calls a specific operation on each child. This archetype exports one operation body for every imported operation signature.

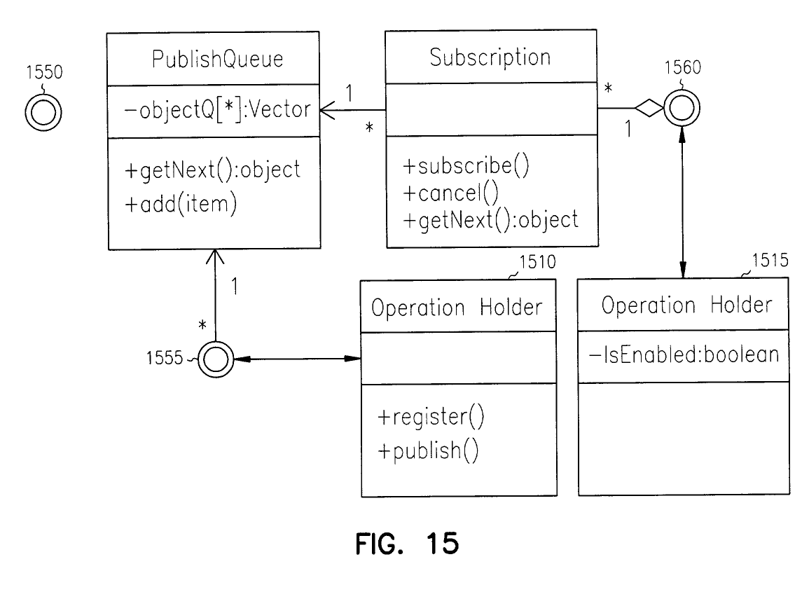

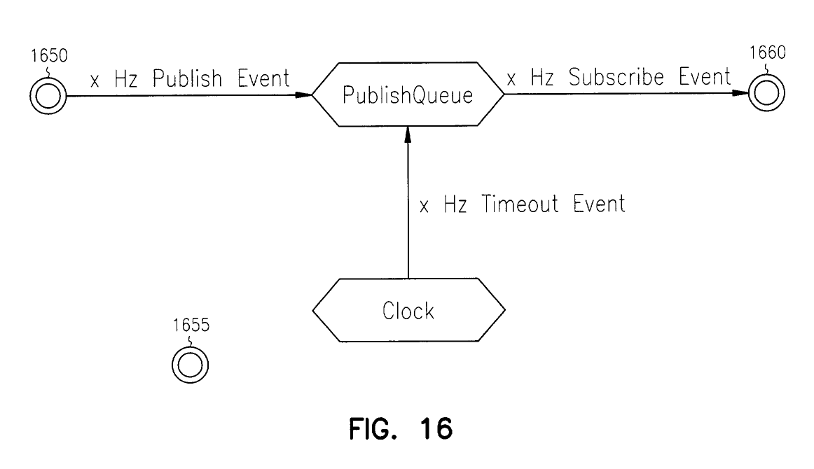

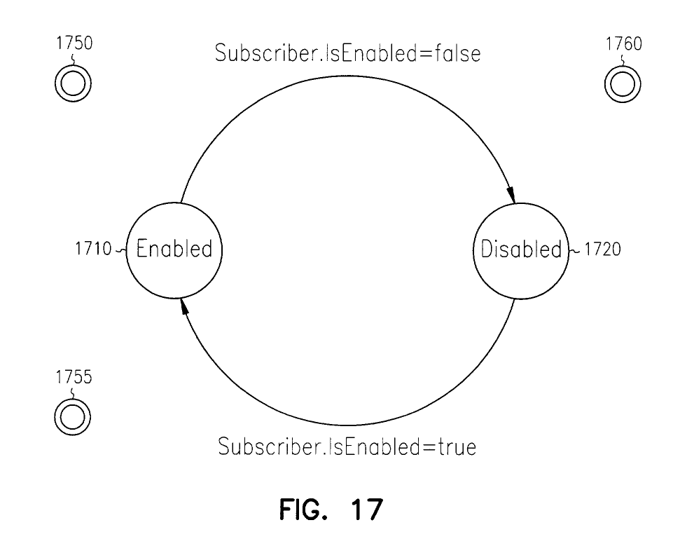

FIGS. 14, 15, 16 and 17 provide another example. FIG. 14 indicates a UML class diagram domain model that is composed of five UML class entities and two Publish/Subscribe archetype instances. The class entities comprise Display 1410, FuelGage 1415, FuelReport 1420, TempGage 1425 and TempReport 1430. The Publish/Subscribe archetype instances comprise PS1 1435 and PS2 1440. The purpose of the Publish/Subscribe design pattern is to define a one-to-many dependency relationship between entities so that when the one entity publishes some information, the other entities are notified. The Publish/Subscribe archetype definition models this design pattern in a manner that is flexible and that can be reused. In this example, the Publish/Subscribe archetype definition is comprised of three portals: Publisher Portal 1450, Published Class Portal 1455, and Subscriber Portal 1460; a single attribute x of type integer; and a single implementation that is composed of three subdiagrams from different modeling notations. These subdiagrams are shown in FIGS. 15, 16 and 17. FIG. 15 shows a subdiagram that conforms to the UML class diagram modeling notation. FIG. 16 shows the subdiagram that conforms to the Periodic Event modeling notation. FIG. 17 shows the subdiagram that conforms to the State-Transition diagram modeling notation.

The purpose of the UML class subdiagram in FIG. 15 is similar to that of the UML class subdiagram of the Composite archetype definition in FIG. 12. It is to specify the software architecture of the archetype. Additionally, this model contains two examples of Operation Holder entities. The purposes of these entities are to project all of their attributes and operations to any classes that are connected to them via equivalence arcs. Note that this connection will be made logically through the corresponding portal. This is one example of how information can flow out of an archetype instance through portals. In this case, it is in the form of additional attributes and/or operations on specific class entities. FuelReport 1420 and TempReport 1430 are assigned the register( ) and publish( ) operations at 1510. Display 1410 is assigned the IsEnabled attribute1515. Note that the class Display 1410 will have the IsEnabled attributed projected onto it twice. As each attribute of a single class must have a unique name, it is possible to rename these attributes PS1IsEnabled and PS2IsEnabled. This name is obtained by concatenating the name of the archetype instance to that of the projected attribute. Also, the internal Publisher Portal 1550 in this subdiagram is not connected to any other modeling entity in this subdiagram, as it does not play a role in this subdiagram. Optionally, this portal need not be visually represented in this subdiagram. An internal Subscriber Portal 1560 and internal Published Class Portal 1555 correspond to respective portals in FIG. 14.

The Periodic Event subdiagram shown in FIG. 16 specifies information that is required for periodic event scheduling. It has internal portals 1650, 1655 and 1660 corresponding to the external portals in FIG. 14. The rates at which events will occur might be different for each instance of the Publish/Subscribe archetype. Therefore, this rate has been made an attribute of type integer on the archetype definition. An appropriate value can then be assigned to this property for each archetype instance. The Periodic Event subdiagram has access to this value when performing analysis and/or generating code.

The State-Transition subdiagram shown in FIG. 17 specifies a process by which the Subscriber class can temporarily disable the subscription service without having to cancel and re-subscribe to it. This model indicates that if the current state is Enabled 1710 and the attribute IsEnabled is false, then the current state becomes Disabled 1720. Likewise, if the current state is Disabled 1720 and the attribute IsEnabled is true, then the current state becomes Enabled 1710. This is one example of how information can flow into an archetype instance through portals. In this case, it is instance-specific attribute value information. Note that the attribute IsEnabled is projected onto the Subscriber by the Operation Holder as described above. Internal portals 1750, 1755 and 1760 are optional in this subdiagram, but are shown as corresponding to the external portals in FIG. 14.

### MAKING AND USING THE INVENTION

Creation of an archetype-enabled modeling tool suite in one embodiment starts with one or more integrated modeling tools capable of supporting models from one or more different modeling notations. Two new node types (archetype and portal) are defined that can be instantiated in models from any modeling notation. Portals are accessories of archetypes; that is they are implicitly connected to archetypes and visually their boundaries may overlap or may be contiguous with the archetype. All types of arcs can connect to portal instances. No arcs can connect directly to an archetype instance.

A new arc type (equivalence arcs) is defined that can be instantiated in models from any modeling notation. Equivalence arcs can be attached between portals and arbitrary modeling entities (or between portals and other portals) such that the portal will appear to be logically, but not necessarily visually, equivalent to the non-portal object on the other end of the arc (or arc-portal chain).

An archetype management tool is provided to allow users to create archetype definitions for instantiation into models. Creation of the tool is straightforward based on the definitions. Archetype definitions include visual representations, portals, implementations, and archetype-specific attributes and operations. Attribute types (including restrictions on the values they may assume) are specified on the archetype definition and the values of each attribute are set on archetype or portal instances. The tool also provides support for managing multiple implementations of archetype definitions. Archetype definitions can have multiple implementations; each of these consists of possibly overlapping sets of subdiagrams, operations, and attributes. The tool also provides the capability to create instances of user-defined archetypes in models from arbitrary modeling notations. The tool further provides a link from each instance of an archetype to its definition so that the subdiagrams of the archetype definition are accessible. It further provides a change notification capability such that all instances of an archetype will be updated upon changes to their archetype definitions, or vice versa.

The modeling tools provide the capability to support subdiagrams. Subdiagrams are one or more models (from various modeling notations) that are linked to a single modeling entity instance such that certain of the instance's accessories (e.g., portals) appear in the subdiagrams.

In other embodiments a specific archetype tool may not be created at all. Archetype use may be a matter of practice, rather than enforced by a tool.

### CONCLUSION

The archetype framework described herein allows for archetypes in and across diverse modeling domains. These archetypes insulate developers from their implementations and behave according to the syntax and semantics of the domain in which they are applied. They also provide reuse through archetype composition, cross-domain aspect modeling, and support for powerful code generation.

Archetypes are domain-independent modeling entities that can contain one or more domain-specific models as well as archetype-specific operations, such as code generation. Since they are domain-independent, they may be instantiated and interpreted from within arbitrary modeling notations. Archetypes provide the mechanism for complex, multi-domain modeling information to be abstracted to a single black-box modeling entity.

The initial motivation behind archetypes was to develop a means of realizing and reusing design patterns for model-based development. This enabled the use of design patterns as basic building blocks of graphical modeling. It was discovered that archetypes are also useful in support of general cross-domain and multi-model code generation.

The use of archetypes has a number of advantages. (1) Archetypes are fully parameterized and reusable. (2) Use of archetypes saves time and makes models more explicit and easier to understand. (3) Archetypes make cross-domain information available to arbitrary modeling notations in support of rich code generation and analysis. (4) Archetypes were designed to realize design patterns as the basic building blocks of model-based design. They can be used to implement (and reuse) common design patterns with complete code generation capabilities.

1. A framework for use of archetypes for graphical model-based development environments, the framework comprising:
a plurality of archetype definitions;
a plurality of implementations for each archetype definition; and
a plurality of domain-independent archetype instance modeling entities derived from each archetype definition.

2. The framework of claim 1 wherein an archetype is a representation of a solution to a problem in a context.

3. The framework of claim 2 wherein selected archetype definitions have user-defined attributes.

4. The framework of claim 3 wherein selected archetype definitions have user-defined operations.

5. The framework of claim 4 wherein an archetype instance is adapted by the values of its attributes to reference a specific implementation.

6. The framework of claim 5 and further comprising portals that are application programming interfaces to archetypes.

7. The framework of claim 6 wherein an archetype instance is a node or arc on a graph having internal details accessible through the portals.

8. The framework of claim 7 wherein selected portals have user-defined attributes.

9. The framework of claim 8 wherein portal attribute values may be derived from other portals or modeling entities.

10. The framework of claim 9 wherein selected archetype instances are components of domain-specific modeling entities.

11. The framework of claim 1 wherein the archetypes support domain-level reuse by archetype instantiation.

12. The framework of claim 1 wherein implementations are comprised of sets of subdiagrams.

13. The framework of claim 12 wherein the implementation may have userdefined attributes and operations.

14. The framework of claim 13 wherein the sets of subdiagrams, operations, and attributes may overlap between implementations.

15. The framework of claim 14 wherein the implementation is adapted by the values of its attributes.

16. The framework of claim 15 and further wherein multiple archetype instances may reference the same implementation.

17. The framework of claim 16 wherein changes in an implementation affect all instances that reference the implementation.

18. The framework of claim 14 wherein the subdiagram is a domain specific model.

19. The framework of claim 18 and further wherein subdiagrams contain portals that correspond to a user-definable subset of the portals that are defined on its archetype definition.

20. The framework of claim 18 wherein a subdiagram is a domain specific visual representation of an aspect of a system or solution.

21. A framework for use of archetypes for graphical model-based development environments, the framework comprising:
means for representing archetype definitions;
means for providing a plurality of implementations of each archetype definition; and
means for providing a plurality of domain-independent archetype instance modeling entities for each archetype definition.

22. The framework of claim 21 and further comprising means for deriving archetype instances from archetype definitions.

23. The framework of claim 22 and further comprising portals acting as application programming interfaces to archetypes.

24. The framework of claim 23 wherein an archetype is a node or arc on a graph having internal details accessible through the portals.

25. The framework of claim 21 and further comprising a subdiagram of an implementation that is a domain specific visual representation of an aspect of a system or solution.

26. A method of programming comprising:
developing one or more archetype definitions;
instantiating one or more archetypes in one or more models;
generating source code from the models.

27. The method of claim 26 wherein at least one archetype instance contains a portal.

28. The method of claim 27 wherein at least one portal is connected to a native modeling entity or another portal by an arc.

29. The method of claim 28 wherein at least one portal or archetype instance has user-defined attributes.

30. The method of claim 29 wherein at least one attribute value is set.

31. The method of claim 30 wherein the result of the generated code is determined by the values of the set and unset attributes.

32. A method of programming related to a problem context, the method comprising:
representing archetypes by graphic images;
implementing a plurality of context-relevant archetype definitions; and
providing a plurality of context relevant subdiagrams, operations, and attributes for each archetype implementation.

33. The method of claim 32 and further comprising:
instantiating one or more archetypes in one or more models;
generating source code from the model.

34. A method of creating a model for programming in a domain, the method comprising:
creating archetype definitions;
providing visual representations of the archetypes;
creating instances of archetypes having domain specific implementations; and
providing portals on the archetypes and archetype instances to access implementations while hiding complexity.
